(19) United States
(12) Patent Application Publication
(10) Pub. No.: US 2004/0234673 A1
(43) Pub. Date: Nov. 25, 2004

(54) Composite composition containing sensitive substances

(76) Inventors: Jean-Francois Letavernier, Wy Dit Joly Village (FR); Alain Pillot, Marges (FR)

Correspondence Address: D Douglas Price, Steptoe & Johnson, 1330 Connecticut Avenue NW, Washington, DC, 20036, US

(21) Appl. No.: 10/486,231

(22) PCT Filed: Aug. 12, 2002
(86) PCT No.: PCT/FR02/02856

(30) Foreign Application Priority Data
Aug. 10, 2001 (FR) 01 10744

(51) Int. Cl. A23L 1/221

(52) U.S. Cl. 426/650

(57) ABSTRACT

The invention relates to a composite composition consisting of: a first amorphous phase of carbon hydrates having a vitreous transition temperature greater than ambient temperature; a second crystalline phase; and a third phase comprising at least one substance selected from aromatic substances, non-aromatic substances that are volatile and/or sensitive to external agents and mixtures of same, which is dispersed using at least one emulsifying agent in the two other phases. The invention also relates to the production method thereof.

The present invention relates to compositions with a composite structure, containing aromatic substances and/or nonaromatic substances which are volatile and/or which are sensitive to external agents, and to the process for manufacturing such compositions.

Flavorings are generally mixtures of several fragile, aromatic substances. Indeed, they generally have a certain percentage of volatile compounds and can also be sensitive to external agents such as light, air or moisture. In addition, flavorings can sometimes interact with each other or with other components of food products and cause deterioration of the odor or the taste of these products in which they are contained.

Consequently, it is sought to package them so as to preserve them without impairing their organoleptic properties and their intensity, while ensuring their availability for their use for flavoring various products.

These flavorings are generally adsorbed onto solid supports such as salts, sugars, polysaccharides or vegetable powders. This option provides no stability to the flavorings.

The usual alternative is to use so-called spray-drying techniques which require the production of an emulsion of the flavoring by means of polysaccharides and/or gums dispersed in water. This emulsion is spray-dried in a stream of hot air. Particles are thus obtained which contain the flavorings, ready for use in food formulations. These products are sometimes called encapsulated or spray-dried flavorings.

However, the spray-dried flavorings thus prepared, and which are well known in the art, have disadvantages such as a substantial loss of volatile aromatic substances, which destabilizes the flavoring obtained compared with the sensory qualities of the initial flavoring.

In addition, these spray-dried flavorings have a short life which does not exceed three months to five months for formulations based on citrus flavorings for example; furthermore, possible incompatibilities between components of the flavoring are not at all avoided.

The applicant has discovered, surprisingly, that the combination of aromatic substances and/or nonaromatic substances which are volatile and/or which are sensitive to external agents, with a specific emulsifying agent, and the dispersion of this combination in mixtures of carbohydrates of a glassy amorphous phase and of crystalline compounds make it possible to obtain markedly improved preservation and compatibility properties for said substances.

Indeed, this incorporation, into the glassy amorphous phase, of crystals and this combination contribute in particular to a significant improvement of the rate of inclusion of the volatile substances of the flavoring, an improved cooling capacity of the extruded product, an extremely resistant final texture, and a reduced hygroscopicity compared with the bound flavorings of the prior art, this being without substantial rise in the extruder outlet temperatures, which might have destroyed or volatilized a large portion of the substances to be incorporated, regardless of the size of the die, from 10 mm to 0.5 mm.

This composition with a composite structure according to the invention therefore makes it possible to bind said substances and in particular to trap them, and thus minimize their degradation over time and to avoid their possible incompatibility with other components of food products such as prepared meals, vegetable soups, sauces, dairy products, confectionery products, pastries or cured meat products.

In addition, this composition with a composite structure has a storage life which is markedly longer than those of the prior art containing aromatic substances, which may be up to a few years, this being without distorting the aromatic profile in nature and intensity, which constitutes a marked advantage compared with conventional methods.

Consequently, this composition with a composite structure therefore makes it possible to prevent the disadvantages cited above.

The subject of the invention is therefore a composition with a composite structure, comprising a first amorphous phase of carbohydrates having a glass transition temperature greater than room temperature, a second crystalline phase and a third phase consisting of at least one substance chosen from aromatic substances, nonaromatic substances which are volatile and/or which are sensitive to external agents, and mixtures thereof, dispersed by means of emulsifying agents in the other two phases.

Another subject of the invention relates to the process for manufacturing these compositions.

The subject of the invention is also the use of this composition as a support for the storage and preservation of flavorings and of food, pharmaceutical or cosmetic substances which are sensitive to external agents, and in food products as mentioned above.

Other subjects, characteristics, aspects and advantages of the invention will emerge still more clearly on reading the description and the various examples which follow.

The composition with a composite structure which is the subject of the invention comprises:

(1) a first amorphous phase of carbohydrates having a glass transition temperature greater than room temperature, preferably greater than 30° C.,

(2) a second crystalline phase, and

(3) a third phase consisting of at least one substance chosen from aromatic substances, nonaromatic substances which are volatile and/or which are sensitive to external agents, and mixtures thereof, dispersed by means of at least one emulsifying agent in the other two phases.

The expression room temperature is understood to mean a temperature of about 20 to 25° C.

The first phase, which is amorphous, preferably comprises a maltodextrin having a dextrose equivalent (DE) which is generally between 1 and 20, preferably between 5 and 18 and better still between 11 and 14; or a mixture of simple sugars such as glucose or maltose, and of oligosaccharides or of polysaccharides such as starch, modified starch, gum arabic, guar gum, carob gum, or carrageenans.

There is used more particularly the maltodextrin with a DE of 11 to 14 marketed in particular by the company Roquette under the name Glucidex 12.

The second phase, which is crystalline, preferably comprises mannitol, a cyclodextrin, a salt, for example sodium chloride or calcium carbonate, glutamic acid or one of its alkali or alkaline-earth metal salts, for example monosodium glutamate, or mixtures thereof. It is possible to use more particularly the mannitols marketed by the company Roquette or alpha-, beta- or gamma-cyclodextrins and their methylated or hydroxyl-propylated derivatives.

The amorphous and crystalline phases preferably constitute from 60 to 90% of the total weight of the composition. The weight ratio of the amorphous phase to the crystalline phase is generally between 50:50 and 70:30.

The third phase generally represents from 5 to 40% of the total weight of the composition.

This third phase consists of at least one substance chosen from aromatic substances, nonaromatic substances which are volatile and/or which are sensitive to external agents such as air, moisture or light, and mixtures thereof.

As aromatic substance which is particularly suitable in the invention, there may be mentioned in particular essential oils such as for example the essential oil of orange, lemon, mandarin or mint; oleoresins such as the oleoresins of pepper, nutmeg or chili pepper; natural or synthetic flavoring substances such as vanillin, ethylvanillin, menthol, eucalyptol, camphor, the extracts of licorice, crab or coffee; spices and seasonings such as sweet pepper, chili pepper or thyme; flavor modifiers such as salts, glutamate; sweeteners such as aspartame; and mixtures thereof.

As examples of a nonaromatic substance which is volatile and/or which is sensitive to external agents, there may be mentioned in particular natural extracts such as polyphenolic compounds and anthocyanins; sulfur compounds such as organic sulfides, for example dimethyl sulfide, sulfur amino acids such as cysteine and methionine; active agents for pharmaceutical use such as ascorbic acid and methyl and amyl salicylates; lipids containing unsaturated fatty acids such as fish, evening primrose or borage oils, and mixtures thereof.

These substances are dispersed by means of at least one emulsifying agent. By way of examples of emulsifying agents which are particularly suitable in the present invention, there may be mentioned in particular phospholipids (for example E322) such as phosphatidylcholine, phosphatidylserine, phosphatidyl-ethanolamine, for example, soybean lecithin, rapeseed lecithin; C₁₀-C₂₀ fatty acid mono- or diglycerides, and preferably the C₁₄/C₁₈ fatty acid mono- and diglycerides marketed under the name Myverol® (E471) by Eastman Kodak; glycerol esters such as E472; sucroglycerides such as E474; polyglyceryl esters such as E475; polyricinoleates such as E476; propanediol esters such as E477; stearoyl lactates such as E481 and E482; sorbitan esters such as E491, E492 and E495; and mixtures thereof.

The emulsifying agents are generally present in proportions of less than 1% by weight, preferably of between 0.2 and 0.6% by weight relative to the total weight of the composition.

The combination of emulsifying agents and of at least one substance chosen from aromatic substances, nonaromatic substances which are volatile and/or which are sensitive to external agents, which is lipophilic, hydrophilic or amphiphilic, leads to an amphiphilic product.

The composition according to the invention may also contain water in small proportions, preferably of between 1 and 20% by weight, better still of less than 5% by weight relative to the total weight of the composition. This proportion of water is in addition to the water intrinsically present in the components of the amorphous and crystalline phases mentioned above.

The composition in accordance with the invention may additionally contain fatty substances such as C₈-C₂₀ fatty acid triglycerides and in particular a mixture of saturated vegetable C₈/C₁₀ fatty acid triglycerides such as the product marketed under the name Miglyol® 812 (E471) (company Huls). The use of fatty substances promotes in particular the extrusion process.

These fatty substances may be used in proportions not exceeding 10% by weight relative to the total weight of the composition.

The compositions in accordance with the invention may also additionally comprise one or more polyols, such as for example propylene glycol, glycerol or alkoxylated alcohols such as polyalkylene glycols, for example polyethylene glycols or copolymers of ethylene oxide and propylene oxide.

These polyols play the role of plasticizers, in other words they lower the glass transition temperature of the meltable fraction of the components of the amorphous phase, and increase the compatibility between the amorphous phase and the dispersed crystalline phase.

When they are present in the composition, their quantity is in particular between 1 and 10% by weight, preferably between 2 and 5% by weight relative to the total weight of the composition.

A particular embodiment of the invention consists in that the composition does not comprise added water and comprises at least one polyol as described above.

Another subject of the present invention consists in a process for manufacturing the compositions with a composite structure according to the invention, as described above.

The process of manufacture according to the present invention comprises the following steps consisting in:

(a) on the one hand, mixing the carbohydrate powders of the amorphous phase and the powders of crystalline compounds as described above; for example, a maltodextrin is mixed with mannitol or a cyclodextrin or a salt, in powdered form in a mixer such as a ploughshare mixer;

(b) on the other hand, mixing the emulsifying agent as described above with at least one substance as described above, chosen from aromatic substances, nonaromatic substances which are volatile and/or which are sensitive to external agents, and mixtures thereof, and then adding water, or at least one polyol which is liquid or meltable under the process conditions, as described above, or a mixture of water/polyol(s) which is (are) liquid or meltable under the process conditions, so as to form an emulsion,

(c) slowly incorporating the emulsion into the powder mixture, with stirring, and

(d) then extruding the mixture so as to obtain at the outlet a composition with a composite structure containing a glassy amorphous phase, in particular based on maltodextrin, and a crystalline phase which comprises in particular intact crystals of mannitol or of cyclodextrin or of a salt, in which phases is dispersed at least one substance chosen from aromatic substances, nonaromatic substances which are volatile and/or which are sensitive to external agents, and mixtures thereof.

In step (b), the emulsion is preferably prepared with stirring at high speed with a device such as Polytron.

According to a particularly preferred embodiment of the invention, water is added, or at least one polyol which is liquid or meltable under the process conditions, or a mixture of water/polyol(s) which is (are) liquid or meltable under the process conditions at the end, without prior emulsification. The process then comprises the following steps consisting in:

(a) on the one hand, mixing the carbohydrate powders of the amorphous phase and the powders of crystalline compounds as described above,

(b′) on the other hand, mixing the emulsifying agent as described above with at least one substance as described above, chosen from aromatic substances, nonaromatic substances which are volatile and/or which are sensitive to external agents, and mixtures thereof,

(c′) slowly incorporating the mixture of step (b′) into the powder mixture, with stirring,

(d′) adding water, or at least one polyol which is liquid or meltable under the process conditions, as described above, or a mixture of water/polyol(s) which is (are) liquid or meltable under the process conditions, and

(e′) then extruding the mixture so as to obtain at the outlet a composition with a composite structure containing a glassy amorphous phase and a crystalline phase, in which phases is dispersed at least one substance chosen from aromatic substances, nonaromatic substances which are volatile and/or which are sensitive to external agents, and mixtures thereof.

A particular embodiment of the invention consists in preserving, at room temperature, the mixture obtained in step (c) or (d′) for one to five days, preferably for 48 hours.

A physical rearrangement of the mixture is then observed, in other words, a compact solid material is obtained which requires an additional step of pregrinding before the extrusion step (d) or (e′). The ground material has in particular a high rate of retention, for example of 35 to 40% approximately of the total quantity of aromatic substances, or nonaromatic substances which are volatile and/or which are sensitive to external agents.

Steps (a) to (c), and (a′) to (d′) are carried out at room temperature.

Preferably, the extrusion is carried out at low temperature, which means that the maximum temperature to which the mixture of step (c) or (d′) is heated is in the interval ranging from about 100 to 140° C.

The mixture to be extruded in step (d) or (e′) is introduced at room temperature into the extruder, and then heated to a temperature of between 100 and 140° C., cooled to a temperature of 80-90° C., and then extruded at a temperature of 75 to 105° C.

The extruded product, in the form of rods or pellets, is hard, brittle, homogeneous, nonexpanded, not very odorous and nonsticky. It is cut at the outlet and cooled.

The products obtained after cutting are hard with an absence of fines. These cut and ground products have remarkable and unexpected properties, such as preservation of the flavoring and nonhygroscopicity. These extruded products also have a solid emulsion structure.

Differential thermal analysis of the composition according to the invention, obtained according to one of the processes as described above, makes it possible to observe the existence of a glass transition at a temperature greater than room temperature (presence of a phase in the glassy state) and of an endotherm corresponding to the melting of the crystals, for example of mannitol, which indeed corresponds to the existence of a composite material: a glassy phase, a crystalline phase, a dispersed phase.

Thermogravimetric analysis successively shows the loss of free water and then the loss of volatile substances at a temperature much greater than their boiling temperature under atmospheric pressure, which corresponds to a retention of the volatile substances until thermal disintegration of the solid network which contains them.

The rate of inclusion of the aromatic substances may be evaluated for example in the following manner.

The aromatic substances bound, that is to say enclosed and adsorbed, may be assayed according to the well-known methods of the European pharmacopoeia 2000, for example, by qualitative and quantitative gas chromatography analysis or by global UV absorption spectroscopy of the aromatic substances.

The results of this assay, combined with those of the assay of the aromatic substances which are simply adsorbed, for example by washing with a solvent such as hexane, make it possible to calculate, by difference, the proportion of aromatic substances effectively trapped in the material or enclosed, and to deduce therefrom the inclusion rate compared with the initial quantity of aromatic substances.

The hygroscopicity may be determined by measuring the water content according to the Karl Fischer process which makes it possible to monitor the water regain.

The search for the degradation products (for example limonene oxide) is carried out by gas chromatography, or even by UV spectroscopy in some cases.

It is also possible to determine the microstructure of the compositions according to the invention by scanning electron microscopy examination.

Moreover, compared with the same flavoring treated by conventional spray-drying, the extruded composition according to the invention is globally more balanced than the spray-dried product, without a predominance of the bottom notes, more fresh, and with a stronger odor. The composition according to the invention leads to the release of the flavoring as rapidly, if not more rapidly, than a spray-dried product, both in cold water and in hot water.

The composition thus obtained is particularly stable. After 18 months in the dark, at a temperature of +15° C. to +25° C., the structure of the composition according to the invention is unchanged, the content of flavoring is unchanged, the tests for monitoring oxidation are unchanged compared with the initial controls, and the tasting tests are equivalent in terms of note and intensity compared with a control stored at −20° C.

The compositions according to the invention are used in particular for the storage and preservation of food or pharmaceutical flavorings, and in food products such as prepared meals, vegetable soups, sauces, dairy products, confectionery products, pastries or cured meat products.

The compositions according to the invention may also be used in pharmaceutical or cosmetic compositions.

The following examples are intended to illustrate the invention without however being of a limiting nature.

### EXAMPLE NO. 1

The following composition is prepared:

| | |
|---|---|
| Orange flavor (*) | 100 g |
| Lecithin (**) | 5 g |
| Water | 43 g |
| Maltodextrin DE 11-14 (***) | 426 g |
| Mannitol (****) | 426 g |

(*) mixture of essential oil of orange and natural aromatic substances.
(**) soybean lecithin, sold under the name emulfluid “E” by the company Lucas-Meyer.
(***) Glucidex ® 12 (company Roquette-Lestrem - France.
(****) Mannitol 60 (company Roquette)

The mannitol and the maltodextrin are mixed in a ploughshare mixer (Lodige or equivalent).

The lecithin is added to the orange flavor; after complete dispersion, water is added and the emulsion is prepared by means of a high speed stirrer (Polytron). The emulsion is slowly incorporated into the powder mixture, with stirring. From this stage, a significant absorption of the aromatic components onto the support is observed; a significant reduction in the odor and a homogeneous absorption which can be verified visually and analytically (UV spectrum of the dispersed species, assay of the total volatile substances, chromatography) are observed.

A common test consists in depositing on a sheet of paper a small quantity of the powder obtained; after a few minutes of contact, no fatty traces should be observed on the paper.

The mixture obtained is regularly introduced into an extrusion device of the Buhler or Clextral type or equivalent with a twin-screw system. The extrusion conditions are indicated below.

| | |
|---|---|
| Barrel No. 1 | (17 cm approximately) cooled |
| | with tap water |
| Barrel No. 2 | +76° C. |
| Barrel No. 3 | +119° C. |
| Barrel No. 4 | +80° C. |
| Barrel No. 5 | +80° C. |
| Outlet temperature | +95° C. |

These temperatures are markedly lower than the usual temperatures, despite the presence of a large crystalline phase.

The rods obtained are cut on leaving the extruder, contributing to a rapid cooling. The extruded product is homogeneous, free of expansion, not very odorous and nonsticky.

The texture of the products obtained acquires, on cooling, an extreme hardness (of the order of 180 Newtons) with an absence of fines. The results are as follows:

| | |
|---|---|
| Content of flavoring: | 9.8% |
| Content of untrapped flavoring: | 0.3% |
| Inclusion rate: | 95% |
| Water content: | 4.1% |
| Very low hygroscopicity. | |

### EXAMPLE NO. 2

The following composition is prepared:

| | |
|---|---|
| Essential oil of orange | 100 g |
| Soybean lecithin | 5 g |
| Water | 40 g |
| Maltodextrin DE 11 to 14 | 600 g |
| Mannitol | 255 g |

The procedure is carried out under the same operating conditions as those of Example No. 1, the difference being that there are incorporated into the pulverulent maltodextrin/mannitol mixture the essential oil and emulsifier mixture, and then the water; an excellent homogeneity of the distribution of the aromatic substances is thus obtained, and the final addition of a very small quantity of water contributes to give a texture of the “semolina” type which is extremely favorable for feeding the extruder.

In the present case, the temperatures used for the extrusion are identical to those of Example No. 1 with the exception of the following:

| | |
|---|---|
| Barrel No. 3 | +140° C. |
| Barrels Nos. 4 and 5 | +70° C. |
| Outlet temperature | +85° C. |

The following results are obtained.

| | |
|---|---|
| Content of essential oil: | 9.8% |
| Inclusion rate: | 98% |
| Water content: | 4.3% |
| No hygroscopicity | |

As regards the preservation over 24 months, the conclusions are identical to those of the preceding trial.

A uniform distribution of lecithin is observed by X fluorescence microscopy.

### EXAMPLE NO. 3

The following composition is prepared:

| | |
|---|---|
| Essential oil of orange | 100 g |
| Soybean lecithin | 5 g |
| Water | 43 g |
| Maltodextrin DE 11 to 14 | 426 g |
| Mannitol | 426 g |

The operating conditions are identical to those of Example No. 2. The following results are obtained:

Content of essential oil: 8.7%

Content of free essential oil: 0.74%

Inclusion rate: 79.6%

### EXAMPLE NO. 4

The following compositions are prepared:

| | 4A | 4B |
|---|---|---|
| Bitter orange essential oil | 100 g | 75 g |
| Soybean lecithin | 2.7 g | 2.7 g |
| Hydrogenated oil (*) | 0 g | 25 g |
| Water | 40 g | 40 g |
| Mannitol | 257.2 g | 257.2 g |
| Maltodextrin DE 11/14 | 600.1 g | 600.1 g |

(*) Miglyol ® 812 (company Huls): mixture of saturated C8/C10 vegetable fatty acid triglycerides

The procedure is carried out in the same manner as in the preceding examples for the mixture of the ingredients above; in the case of trial 4B, Miglyol® is added to the essential oil and lecithin mixture.

The composition is then introduced into an extrusion device identical to that of Example No. 1 and the extrusion parameters are indicated below.

| | 4A | 4B |
|---|---|---|
| Temperatures of the | | |
| barrels | | |
| No. 2 | 65° C. | 65° C. |
| No. 3 | 117° C. | 101° C. |
| No. 4 | 117° C. | 102° C. |
| No. 5 | 94° C. | 108° C. |
| Outlet temperature | 93° C. | 102° C. |

Inclusion rates of 55% and 81% are obtained for Examples 4A and 4B respectively.

### EXAMPLE NO. 5

The following composition is prepared:

| | |
|---|---|
| Lemon flavor (*) | 100 g |
| Soybean lecithin | 5 g |
| Water | 40 g |
| Mannitol | 255 g |
| Maltodextrin DE 11/14 | 600 g |

(*) mixture of essential oils and natural flavoring substances.

The operating conditions are identical to those of Example No. 2.

The results are excellent, which should be emphasized given the extreme brittleness of this type of aromatic composition. The following results are obtained.

| | |
|---|---|
| Inclusion rate: | 92% |
| Water content: | 7% |

Sensory analysis shows an excellent preservation after 12 months (+15°/+25° C.) which is confirmed by chromatographic analysis: no oxidation product appeared.

### EXAMPLE NO. 6

The following composition is prepared:

| | |
|---|---|
| Mulberry flavor (*) | 92 g |
| Soybean lecithin | 2.5 g |
| Water | 40 g |
| Mannitol | 259.6 g |
| Maltodextrin DE 11/14 | 605.9 g |

(*) mixture of substances identical to natural substances: capric, caproic, butyric, formic, isovalerianic, tiglic and valerianic acids, myrhh essence, eugenol, acetaldehyde, phenylacetaldehyde, hexanal, esters (acetates), amyl, isoamyl, isobutyl and propyl alcohols, hexanol, gamma-delta-decalactones, dimethyl sulfide, frambinone, hedione, ionones, maltol, furaneol, vanillin, damascone, ambrettolide.

The operating conditions are identical to those of Example No. 2. The following results are obtained.

| | |
|---|---|
| Inclusion rate: | 89.7% |
| Water content: | 6.7% |

The conclusions are strictly identical to those of Example No. 5 for an identical duration of preservation.

### EXAMPLE NO. 7

The following composition is prepared:

| | 7A | 7B |
|---|---|---|
| Peach flavor (*) | 100 g | 75 g |
| Soybean lecithin | 2.5 g | 2.5 g |
| Propylene glycol | 0 g | 20 g |
| Water | 40 g | 20 g |
| Mannitol | 257.2 g | 257.2 g |
| Maltodextrin DE 11/14 | 600.2 g | 600.2 g |

(*) mixture of flavoring substances identical to natural substances: acetates, hexanol, linalol, citronellol, geraniol, 2-isopropyl-4-methyl-thiazole, acetic acid, butyric acid, benzoic acid, benzaldehyde, anisaldehyde, mint and lemon essential oils, C₈-C₁₁ lactones.

The operating conditions are identical to those of Example No. 2. The following results are obtained:

| | 7A | 7B |
|---|---|---|
| Inclusion rate: | 93% | 88% |
| Water content: | 7.5% | 8% |

Preservation is excellent after 10 months at room temperature.

### EXAMPLE NO. 8

The following composition is prepared:

| | 8A | 8B |
|---|---|---|
| Orange essential oil | 100 g | 100 g |
| Myverol ® (*) | 5 g | 5 g |
| Water | 40 g | 40 g |
| Mannitol | 0 g | 127.5 g |
| Beta-cyclodextrin | 255 g | 127.5 g |
| Maltodextrin DE 11/14 | 600 g | 600 g |

(*) E471 C₁₄/C₁₈ fatty acid mono- and diglycerides (Eastman-Kodak)

The operating conditions are comparable to those of Example No. 2. The following results are obtained.

| | 8A | 8B |
|---|---|---|
| Inclusion rate: | 95% | 97% |
| Water content: | 10.3% | 16% |

The product obtained has performance features comparable to those of Example 2 with excellent preservation over 10 months.

### EXAMPLE NO. 9

The following composition is prepared:

| | 9A | 9B |
|---|---|---|
| Tomato flavor (*) | 6 g | 12 g |
| Miglyol ® | 94 g | 40 g |
| Soybean lecithin | 2.5 g | 2.5 g |
| Water | 40 g | 40 g |
| Mannitol | 257 g | 281 g |
| Maltodextrin DE 11/14 | 600.5 g | 600.5 g |

(*) mixture of flavoring substances identical to natural substances, including mainly: dimethyl sulfide, acetyl methyl carbinol, hexanal, furfural, methional, acetylfuran, benzaldehyde, linalol, terpineol, acetylfuran, benzaldehyde, linalol, terpineol, citral, eugenol, ionones, damascone. . .

The mixing conditions are identical to those of the preceding examples for the mixing of the ingredients of the compositions and the extrusion parameters are indicated below.

| Temperatures of the barrels | |
|---|---|
| No. 2 | 61° C. |
| No. 3 | 104° C. |
| No. 4 | 104° C. |
| No. 5 | 93° C. |
| Outlet temperature | 98° C. |

The following results are obtained:

| | 9A | 9B |
|---|---|---|
| Inclusion rate: | 79% | 89% |
| Water content: | 6.9% | 7.2% |

This example shows the importance of the invention as regards the volatility and the sensitivity to external agents of the components of the flavoring.

This composition is difficult to spray-dry on conventional supports. An aromatic imbalance and a loss of intensity are observed in this case, and the preservation does not exceed 4 months.

In the present case, the composition obtained according to the invention shows very little deterioration compared with the initial mixture, underlining not only the taste benefit but also the economic benefit of the process and of the material claimed. The preservation data make it possible to envisage a satisfactory stability over 12 months at room temperature.

Moreover, the use of this protective flavoring at the industrial processing stage (prepared meals, mixtures for sauces and vegetable soups) shows a compatibility which is much higher than that of conventional presentations (spray-dried or granulated).

### EXAMPLE NO. 10

The following composition is prepared:

| | |
|---|---|
| Vanillin | 120 g |
| Soybean lechithin | 2.5 g |
| Miglyol ® | 2.5 g |
| Water | 40.5 g |
| Mannitol | 234 g |
| Maltodextrin DE 11/14 | 600.5 g |

The Miglyol® and the lecithin are mixed. The mixture is then added to the vanillin, which has been incorporated beforehand into the mannitol and the maltodextrin, and then water is added.

The extrusion parameters are indicated below.

| Temperature of the | |
|---|---|
| barrels (° C.) | |
| No. 2 | 67 |
| No. 3 | 100 |
| No. 4 | 100 |
| No. 5 | 78 |
| Outlet temperature | 94 |

The following results are obtained:

| | |
|---|---|
| Inclusion rate: | 80% |
| Water content: | 7.1% |

The vanillin (melting point +80/81° C.—Merck Index 9^{th} edition) undergoes melting during the process followed by a rearrangement: microscopic examination shows a complex sheeted structure. The products obtained after cutting are extremely resistant.

### EXAMPLE NO. 11

The following composition is prepared:

| | |
|---|---|
| Liquid menthol | 100 g |
| Soybean lecithin | 2.5 g |
| Water | 40 g |
| Mannitol | 240 g |
| Maltodextrin DE 11/14 | 617.5 g |

The menthol+lecithin mixture is incorporated into the premixture of powders and the water is then added.

The extrusion parameters are identical to those of Example No. 2. The following results are obtained.

| | |
|---|---|
| Inclusion rate: | 83% |
| Water content: | 7.9% |

A physically stable, solid form is obtained which can be used for confectionery type applications. The menthol is chemically stable.

Incidentally, the use of a menthol as a solid inclusion makes it possible to prepare delayed release formulations and therefore flavorings with a prolonged effect.

### EXAMPLE NO. 12

The following compositions are prepared:

| | 12A | 12B |
|---|---|---|
| Mixture of spices (*) | 100 g | 100 g |
| Water | 43 g | 43 g |
| Mannitol | 257 g | 428.5 g |
| Maltodextrin DE 11/14 | 600 g | 428.5 g |

(*) Mixture of oleoresins of sweet pepper, nutmeg, essential oils of garlic, nutmeg, natural flavoring substances.

Temperatures of the barrels (° C.):

| | |
|---|---|
| No. 1 | 17 |
| No. 2 | 75 |
| No. 3 | 116 |
| No. 4 | 116 |
| No. 5 | 91 |
| Outlet temperature (° C.) | 94 |

The following results are obtained:

| | 12A | 12B |
|---|---|---|
| Inclusion rate: | 92% | 88% |
| Water content: | 7.0% | 7.3% |

The products obtained become, after cutting, extremely hard and nonhygroscopic within a few hours.

The determination of the piperine content by UV absorption spectroscopy made it possible to monitor the quality of the dispersion of the flavoring in the mixture to be extruded, of the finished product obtained, and its preservation.

The physicochemical and sensory analyses show a preservation of the intensity which is practically total over 14 months at room temperature. The study of the preservation of the flavoring “in context”, under industrial process conditions of use (in a protein and starch matrix, for 10 minutes at 95° C., 98% relative humidity) shows a stability much greater than that of traditional formulations.

Similar conclusions followed the study of preservation for 60 days at +35° C.

### EXAMPLE NO. 13

The following composition is prepared:

| | |
|---|---|
| Mixture of spices (*) | 100 g |
| Water | 30 g |
| Mannitol | 160 g |
| Sodium chloride | 50 g |
| Monosodium glutamate (**) | 60 g |
| Maltodextrin DE 11/14 | 600 g |

(*) mixture of oleoresins of sweet pepper and nutmeg, essential oils of garlic and nutmeg, natural flavoring substances, Myverol ® (5%) (E471) sold by Eastman Kodak.
(**) E621 sold by the company Ajinomoto

The procedure is carried out in the same manner as in Example No. 12. The following results are obtained.

| | |
|---|---|
| Inclusion rate: | 89% |
| Water content: | 6.2% |

### EXAMPLE NO. 14

The following composition is prepared:

| | |
|---|---|
| Mulberry flavor(*) | 92 g |
| Soybean lecithin | 2.5 g |
| Propylene glycol | 35 g |
| Mannitol | 260 g |
| Maltodextrin DE 11/14 | 610.5 g |

(*) mixture of substances identical to natural substances: capric, caproic, butyric, formic, isovalerianic, tiglic and valerianic acids, myrhh essence, eugenol, acetaldehyde, phenylacetaldehyde, hexanal, esters (acetates), amyl, isoamyl, isobutyl and propyl alcohols, hexanol, gamma-delta-decalactones, dimethyl sulfide, frambinone, hedione, ionones, maltol, furaneol, vanillin, damascone, ambrettolide.

The operating conditions are identical to those of Example No. 2, the exception being that the water is replaced by propylene glycol, the final powdery mixture is allowed to stand at 20° C.±5° C. for 48 hours, which allows the formation of a solid and compact material, and the latter is pulverized by means of a cutter in order to obtain a material in the form of semolina. This material already exhibits a non-negligible retention of flavoring, that is to say that 35% of the total quantity of the flavoring cannot be desorbed by washing with hexane or with acetonitrile.

This material is then introduced in the form of semolina into the extruder and the following results are obtained.

| | |
|---|---|
| Inclusion rate: | 92% |
| Water content: | 3.9% |

1-24. Cancel

25. A composition with a composite structure, comprising a first amorphous phase of carbohydrates having a glass transition temperature greater than room temperature, a second crystalline phase and a third phase consisting of at least one substance which is an aromatic substance, a nonaromatic substance which is volatile and/or which is sensitive to an external agent, or a mixture thereof, dispersed by means of at least one emulsifying agent in the first and second phases.

26. The composition as claimed in claim 25, wherein the amorphous phase comprises a maltodextrin having a dextrose equivalent of between 1 and 20, or a mixture of simple sugars and of oligosaccharides or of polysaccharides.

27. The composition as claimed in claim 26, wherein the amorphous phase comprises a maltodextrin having a dextrose equivalent of between 5 and 18

28. The composition as claimed in claim 26, wherein the amorphous phase comprises a maltodextrin having a dextrose equivalent of between 11 and 14.

29. The composition as claimed in claim 25, wherein the crystalline phase comprises mannitol, a cyclodextrin, a salt, glutamic acid or one of its alkali or alkaline-earth metal salts, or a mixture thereof.

30. The composition as claimed in claim 29, wherein-the salt is sodium chloride or calcium carbonate.

31. The composition as claimed in claim 25, wherein the aromatic substance is an essential oil, an oleoresin, a natural or synthetic flavoring substance or a spice or seasoning, a flavor modifier, a sweetener or a mixture thereof.

32. The composition as claimed in claim 25, wherein the nonaromatic substance which is volatile and/or sensitive to an external agent is a natural extract, sulfur compound, active agent for pharmaceutical use, lipid containing unsaturated fatty acid, or a mixture thereof.

33. The composition as claimed in claim 32, wherein the nonaromatic substance which is volatile and/or sensitive to an external agent is a polyphenolic compound, an anthocyanin, a dimethyl sulfide, cysteine, methionine, ascorbic acid, fish, borage or an evening primrose oil.

34. The composition as claimed in claim 25, wherein the emulsifier is a phospholipid, phosphatidylethanolamine, a C₁₀-C₂₀ fatty acid mono- or diglyceride, a sorbitan ester, a sucroglyceride, a glycerol ester, a polyglyceryl ester, a polyricinoleate, a propanediol ester, a stearoyl lactate or a mixture thereof.

35. The composition as claimed in claim 34, wherein the phospholipid is phosphatidylcholine or phosphatidylserine.

36. The composition according to claim 25, wherein the emulsifier is present in a proportion of less than 1% by weight relative to the weight of the composition.

37. The composition according to claim 36, wherein the emulsifier is present in a proportion of between 0.2 and 0.6% by weight

38. The composition according to claim 25, wherein the composition contains water in a proportion of between 1 and 20% by weight relative to the total weight of the composition.

39. The composition according to claim 25, wherein the composition contains water in a proportion of less than 5%.

40. The composition as claimed in claim 25, wherein the composition additionally contains a fatty substance in a proportion not exceeding 10% by weight relative to the total weight of the composition.

41. The composition as claimed in claim 40, wherein the fatty substance is a C₈-C₂₀ fatty acid triglyceride, a mixture of saturated vegetable C₈/C₁₀ fatty acid triglycerides, or a mixture thereof.

42. The composition as claimed in claim 25, wherein the composition additionally contains at least one polyol which is propylene glycol, glycerol or an alkoxylated alcohol.

43. The composition as claimed in claim 42, wherein the polyol is present in a quantity of between 1 and 10% by weight relative to the total weight of the composition.

44. The composition as claimed in claim 42, wherein the polyol is present in a quantity of between 2 and 5% by weight.

45. The composition as claimed in claim 25, wherein the amorphous and crystalline phases constitute from 60 to 90% of the total weight of the composition.

46. The composition as claimed in claim 25, wherein the weight ratio of the amorphous phase to the crystalline phase is between 50:50 and 70:30.

47. The composition as claimed in claim 25, wherein the third phase represents from 5 to 40% of the total weight of the composition.

48. A method of storing and preserving food or a pharmaceutical, comprising using the composition of claim 25 to store or preserve the food or pharmaceutical.

49. The method of claim 48, wherein the food is a food product.

50. The method of claim 25, wherein the pharmaceutical is a cosmetic composition.

51. A process for manufacturing a composition with a composite structure as claimed in claim 25, wherein the process comprises the following steps:
(a) mixing the carbohydrate powder of the amorphous phase and the powder of the crystalline compound;
(b) mixing the emulsifying agent with at least one substance which is an aromatic substance, nonaromatic substance which is volatile and/or which is sensitive to an external agent, or a mixture thereof, and then adding water, or at least one polyol which is liquid or meltable under the process conditions, or a mixture of water/polyol which is liquid or meltable under the process conditions, so as to form an emulsion;
(c) slowly incorporating the emulsion into the powder mixture, with stirring; and
(d) then extruding the mixture so as to obtain at an outlet a composition with a composite structure containing a glassy amorphous phase and a crystalline phase, in which phases is dispersed at least one substance which is an aromatic substance, a nonaromatic substance which is volatile and/or sensitive to an external agent, or a mixture thereof.

52. A process for manufacturing a composition with a composite structure as claimed in claim 25, wherein the process comprises the following steps:
(a) mixing the carbohydrate powder of the amorphous phase and the powder of the crystalline compound;
(b′) mixing the emulsifying agent with at least one substance which is an aromatic substance, nonaromatic substance which is volatile and/or sensitive to an external agent, or a mixture thereof;
(c′) slowly incorporating the mixture of step (b′) into the powder mixture, with stirring;
(d′) adding water, or at least one polyol which is liquid or meltable under the process conditions, or a mixture of water/polyol which is liquid or meltable under the process conditions; and
(e′) then extruding the mixture so as to obtain at an outlet a composition with a composite structure containing a glassy amorphous phase and a crystalline phase, in which phases is dispersed at least one substance which is an aromatic substance, nonaromatic substance which is volatile and/or sensitive to an external agent, or a mixture thereof.

53. The process as claimed in claim 51, wherein the mixture obtained in step (c) is preserved at room temperature for one to five days and the mixture is ground before extrusion.

54. The process as claimed in claim 51, wherein the mixture obtained in step (d′) is preserved at room temperature for one to five days and the mixture is ground before extrusion.

55. The process as claimed in claim 53, wherein the mixture obtained in step (c) is preserved at room temperature for 48 hours.

56. The process as claimed in claim 54, wherein the mixture obtained in step (d′) is preserved at room temperature for 48 hours.

57. The process as claimed in claim 51, wherein the mixture to be extruded is introduced at room temperature into an extruder, and then heated to a temperature of between 100 and 140° C., cooled to a temperature of 80-90° C., and then extruded at a temperature of 75 to 105° C.

58. The process as claimed in claim 52, wherein the mixture to be extruded is introduced at room temperature into an extruder, and then heated to a temperature of between 100 and 140° C., cooled to a temperature of 80-90° C., and then extruded at a temperature of 75 to 105° C.
